(19) United States
(12) Patent Application Publication
(10) Pub. No.: US 2026/0353444 A1
(43) Pub. Date: Nov. 5, 2026

(54) CHANNEL ACCESS PRIORITY

(71) Applicant: Nokia Technologies Oy, Espoo (FI)

(72) Inventors: Jianguo LIU, Shanghai (CN); Renato Barbosa ABREU, Aalborg (DK); Vinh VAN PHAN, Oulu (FI); Yong LIU, Shanghai (CN); Nuno Manuel KIILERICH PRATAS, Gistrup (DK); Ling YU, Kauniainen (FI); Torsten WILDSCHEK, Gloucestershire (GB); Naizheng ZHENG, Beijing (CN); Timo Erkki LUNTTILA, Espoo (FI)

(73) Assignee: Nokia Technologies Oy, Espoo (FI)

(21) Appl. No.: 19/105,540

(22) PCT Filed: Aug. 22, 2022
(86) PCT No.: PCT/CN2022/114060

§ 371 Date: Feb. 21, 2025

(51) Int. Cl. H04W 74/0808; H04L 5/00; H04W 72/25; H04W 72/566; H04W 92/18

(52) U.S. Cl. CPC H04W 74/0808; H04L 5/0055; H04W 72/25; H04W 72/566; H04W 92/18

(57) ABSTRACT

Certain examples of the present disclosure relate to an apparatus, method and computer program for determining channel access priority. Certain examples provide apparatus (10) comprising: means (11) for determining information indicative of a channel access priority (p) for a physical sidelink feedback channel, PSFCH, transmission (205) based at least in part on: information indicative of at least one status of a last at least one PSFCH transmission (204); or information indicative of a cast type of a sidelink, SL, transmission (202) that is associated with the PSFCH transmission (205).

### TECHNOLOGICAL FIELD

Various examples of the present disclosure relate to the field of data communication, and in particular to: an apparatus, method and computer program for determining channel access priority. Certain examples, though without prejudice to the foregoing, relate to: a user equipment for determining a channel access priority class for a transmission over a physical sidelink feedback channel.

### BACKGROUND

Conventional methods of determining channel access priority for transmissions (such as for Physical Sidelink Feedback Channel, PSFCH, transmissions) are not always optimal.

In some circumstances it may be desirable to provide an improved apparatus, method and computer program for determining channel access priority for transmissions, such as PSFCH transmissions.

The listing or discussion of any prior-published document or any background in this specification should not necessarily be taken as an acknowledgement that the document or background is part of the state of the art or is common general knowledge. One or more aspects/examples of the present disclosure may or may not address one or more of the background issues.

### BRIEF SUMMARY

The scope of protection sought for various embodiments of the invention is set out by the claims.

According to various, but not necessarily all, examples of the disclosure there are provided examples as claimed in the appended claims. Any examples and features described in this specification that do not fall under the scope of the independent claims are to be interpreted as examples useful for understanding various embodiments of the invention.

According to at least some examples of the disclosure there is provided an apparatus comprising: means for determining information indicative of a channel access priority for a physical sidelink feedback channel, PSFCH, transmission based at least in part on:
information indicative of at least one status of a last at least one PSFCH transmission; or
information indicative of a cast type of a sidelink, SL, transmission that is associated with the PSFCH transmission.

According to various, but not necessarily all, examples of the disclosure there is provided a method comprising:
determining information indicative of a channel access priority for a physical sidelink feedback channel, PSFCH, transmission based at least in part on:
   information indicative of at least one status of a last at least one PSFCH transmission; or
   information indicative of a cast type of a sidelink, SL, transmission that is associated with the PSFCH transmission.

According to various, but not necessarily all, examples of the disclosure there is provided a chipset comprising processing circuitry configured to perform the above-mentioned method.

According to various, but not necessarily all, examples of the disclosure there is provided a module, circuitry, device, User Equipment and/or system comprising means for performing the above-mentioned method.

According to various, but not necessarily all, examples of the disclosure there is provided a computer program comprising instructions, which when executed by an apparatus, cause the apparatus to perform:
determining information indicative of a channel access priority for a physical sidelink feedback channel, PSFCH, transmission based at least in part on:
   information indicative of at least one status of a last at least one PSFCH transmission; or
   information indicative of a cast type of a sidelink, SL, transmission that is associated with the PSFCH transmission.

According to various, but not necessarily all, examples of the disclosure there is provided an apparatus comprising:
at least one processor; and
at least one memory storing instructions that, when executed by the at least one processor, cause the apparatus at least to:
determine information indicative of a channel access priority for a physical sidelink feedback channel, PSFCH, transmission based at least in part on:
   information indicative of at least one status of a last at least one PSFCH transmission; or
   information indicative of a cast type of a sidelink, SL, transmission that is associated with the PSFCH transmission.

According to various, but not necessarily all, examples of the disclosure there is provided a non-transitory computer readable medium encoded with instructions that, when executed by at least one processor, causes at least the following to be perform:
determining information indicative of a channel access priority for a physical sidelink feedback channel, PSFCH, transmission based at least in part on:
   information indicative of at least one status of a last at least one PSFCH transmission; or
   information indicative of a cast type of a sidelink, SL, transmission that is associated with the PSFCH transmission.

In some, but not necessarily all examples, the PSFCH transmission is in an unlicensed band.

In some, but not necessarily all examples, the information indicative of a channel access priority is indicative of at least one selected from the group of:
a priority class for use in a Listen Before Talk, LBT, procedure;
a priority class for use in an unlicensed band;
a Channel Access Priority Class, CAPC;
a Contention Window, CW; and
a Channel Occupancy Time, COT.

In some, but not necessarily all examples, the information indicative of at least one status of the last at least one PSFCH transmission comprises information indicative of at least one selected from the group of:
a channel access status of the last at least one PSFCH transmission;
whether the last at least one PSFCH transmission failed or was successful;
whether an LBT procedure, for transmitting the last at least one PSFCH transmission, failed or was successful;
an LBT success rate for the last one or more PSFCH transmissions;
a number of LBT successes for the last one or more PSFCH transmissions;
whether the PSFCH transmission comprises a re-transmission of information that failed to be successfully transmitted via the last at least one PSFCH transmission;
allocation of resources for the PSFCH transmission, wherein the resources are allocated for re-transmitting information that failed to be successfully transmitted via the last at least one PSFCH transmission; and
whether the PSFCH transmission is within a channel occupancy time, COT, shared by a UE.

In some, but not necessarily all examples, the means for determining information indicative of the channel access priority for the PSFCH transmission comprises:
means for determining a first candidate priority class for the PSFCH transmission;
means for determining a second candidate priority class for the PSFCH transmission; and
means for selecting at least one of a first candidate priority class and a second candidate priority class.

In some, but not necessarily all examples, at least one selected from the group of:
the first and/or second candidate priority classes are pre-defined;
the first and/or second candidate priority classes are configured to the apparatus;
the first candidate priority class is configured to have a lower channel access priority than the second candidate priority class;
the first candidate priority class is determined based at least in part on a channel access priority of one or more SL transmissions associated with the transmission;
the second candidate priority class is determined based at least in part on a channel access priority of one or more SL transmissions associated with the transmission;
the second candidate priority class is determined based at least in part on the first candidate priority class; and
the second candidate priority class is determined based at least in part on the first candidate priority class and a priority class offset.

In some, but not necessarily all examples, the means for selecting one of the first and second candidate priority classes comprises means for selecting one of the first and second candidate priority classes in accordance with at least one selection criterion.

In some, but not necessarily all examples, the at least one selection criterion comprises selecting the first candidate priority class by default.

In some, but not necessarily all examples, the at least one selection criterion comprises selecting the second candidate priority class in response to at least one of:
determining whether the PSFCH transmission is a retransmission of at least a part of a previously attempted PSFCH transmission;
determining whether the PSFCH transmission is a re-transmission of feedback previously attempted to be transmitted;
determining whether the PSFCH transmission is a re-transmission of a Hybrid Automatic Repeat Request Acknowledgement, HARQ-ACK, or Negative Acknowledgement, NACK previously attempted to be transmitted;
determining a type of resource for the PSFCH transmission;
determining whether resources allocated for the PSFCH transmission are resources allocated for re-transmitting information that failed to be successfully transmitted via the last at least one PSFCH transmission; and
determining whether at least a HARQ-ACK of a last one or more PSFCH transmissions could not be transmitted via earlier allocated resources due to an LBT failure.

In some, but not necessarily all examples, the at least one selection criterion comprises selecting the second candidate priority class in response to:
determining whether an LBT success rate of a number of previous PSFCH transmissions is less than a threshold value.

In some, but not necessarily all examples, the at least one selection criterion comprises selecting the second candidate priority class in response to:
determining whether a number of LBT successes of a number of the last PSFCH transmissions is less than a threshold value.

In some, but not necessarily all examples, the at least one selection criterion comprises selecting the second candidate priority class in response to:
determining whether the SL transmission is a unicast transmission.

In some, but not necessarily all examples, the apparatus further comprises:
means for receiving configuration information for enabling the apparatus to determine the at least one selection criterion to apply for selecting one of the first candidate priority class and the second candidate priority class.

In some, but not necessarily all examples, the apparatus further comprises:
means for determining at least one selection criterion to apply based at least in part on a cast type of the SL transmission that is associated with the PSFCH transmission.

In some, but not necessarily all examples, the apparatus further comprises:
means for receiving configuration information for enabling the apparatus to determine the information indicative of the channel access priority for the PSFCH transmission.

In some, but not necessarily all examples, the configuration information comprises an indication of at least one selected from the group of:
a first candidate priority class;
a second candidate priority class;
an offset between a first candidate priority class and a second candidate priority class;
a number of the last PSFCH transmissions;
a threshold transmission success rate;
a threshold number of successful transmissions;
the cast type of the SL transmission that is associated with the PSFCH transmission; and
one or more selection criteria the apparatus is to apply.

In some, but not necessarily all examples, the cast type comprises at least one of: a groupcast and a unicast.

In some, but not necessarily all examples, the SL transmission that is associated with the PSFCH transmission comprises a physical sidelink shared channel, PSSCH, transmission.

In some, but not necessarily all examples, the apparatus further comprises:
means for causing performance of a channel access procedure for transmitting the transmission based at least in part on the determined information indicative of a channel access priority.

While the above examples of the disclosure and optional features are described separately, it is to be understood that their provision in all possible combinations and permutations is contained within the disclosure. It is to be understood that various examples of the disclosure may comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION OF THE DRAWINGS

Some examples will now be described with reference to the accompanying drawings in which:

FIG. 1 shows an example of the subject matter described herein;

FIGS. 2(a)-(f) shows other examples of the subject matter described herein;

FIG. 3 shows another example of the subject matter described herein;

FIG. 4 shows another example of the subject matter described herein;

FIGS. 5(a) and (b) show other examples of the subject matter described herein;

FIG. 6 shows another example of the subject matter described herein;

FIG. 7 shows another example of the subject matter described herein;

FIG. 8 shows another example of the subject matter described herein;

FIG. 9 shows another example of the subject matter described herein;

FIG. 10 shows another example of the subject matter described herein;

FIG. 11 shows another example of the subject matter described herein; and

FIG. 12 shows another example of the subject matter described herein.

The figures are not necessarily to scale. Certain features and views of the figures may be shown schematically or exaggerated in scale in the interest of clarity and conciseness. For example, the dimensions of some elements in the figures may be exaggerated relative to other elements to aid explication. Similar reference numerals are used in the figures to designate similar features. For clarity, all reference numerals are not necessarily displayed in all figures.

In the drawings (and description) a similar feature may be referenced by the same three-digit number. In the drawings (and description), an optional subscript to the three-digit number may be used to differentiate different instances of similar features. Therefore, a three-digit number without a subscript may be used as a generic reference and the three-digit number with a subscript may be used as a specific reference. A subscript may comprise a single digit that labels different instances. A subscript may comprise two digits including a first digit that labels a group of instances and a second digit that labels different instances in the group.

### ABREVIATIONS/DEFINITIONS

5G Fifth Generations
ACK Acknowledgement
CAPC Channel Access Priority Class
CCA Clear Channel Assessment
CG Configured Grant
COT Channel Occupancy Time
CSI Channel State Information
CW Contention Window
DL Downlink
gNB gNodeB
HARQ Hybrid Automatic Repeat Request
LBT Listen Before Talk
NR New Radio
PSCCH Physical Sidelink Control Channel
PSFCH Physical Sidelink Feedback Channel
PSSCH Physical Sidelink Shared Channel
PUCCH Physical Uplink Control Channel
RAN Radio Access Network
Rx Receiver
SCI Sidelink Control Information
SL SideLink
TB Transfer Block
Tx Transmitter
U Unlicensed
UE User Equipment
UL Uplink

### DETAILED DESCRIPTION

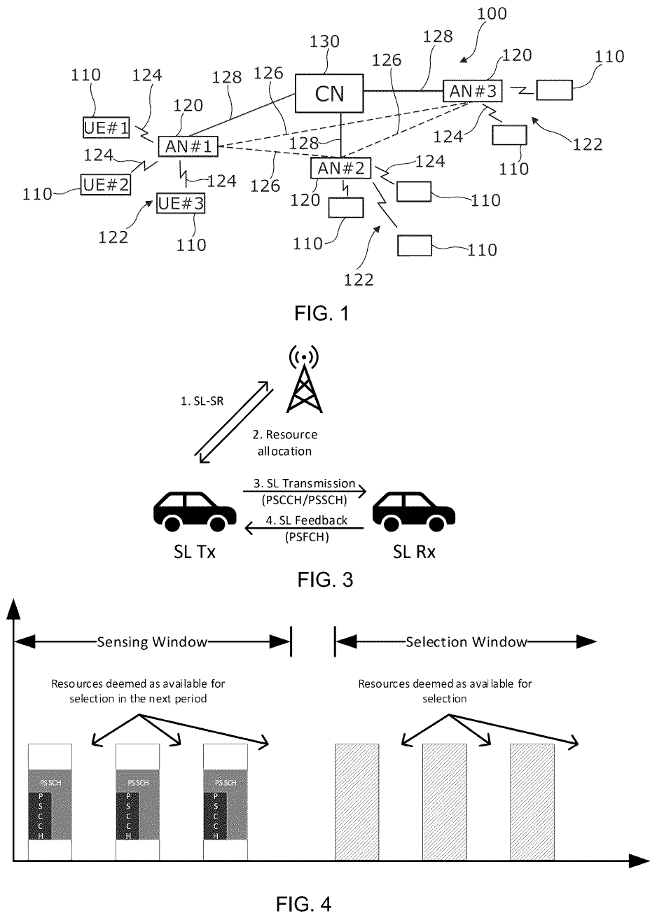

FIG. 1 schematically illustrates an example of a network 100 comprising a plurality of network nodes including terminal nodes 110 (also referred to as User Equipment, UE), access nodes 120 and one or more core nodes 130. The terminal nodes 110 and access nodes 120 communicate with each other. The access nodes 120 communicate with the one or more core nodes 130. The one or more core nodes 130 may, in some but not necessarily all examples, communicate with each other. The one or more access nodes 120 may, in some but not necessarily all examples, communicate with each other.

The network 100 is in this example a radio telecommunications network, i.e. a Radio Access Network, RAN, in which at least some of the terminal nodes 110 and access nodes 120 communicate with each other using transmission/reception of radio waves.

The RAN 100 may be a cellular network comprising a plurality of cells 122 each served by an access node 120. The access nodes 120 comprise cellular radio transceivers. The terminal nodes 110 comprise cellular radio transceivers.

In the particular example illustrated, the network 100 is a Next Generation (NG) or New Radio (NR) network. NR is the Third Generation Partnership Project (3GPP) name for Fifth Generation (5G) technology.

The interfaces between the terminal nodes 110 and the access nodes 120 are radio interfaces 124 (e.g. Uu interfaces). The interfaces between the access nodes 120 and one or more core nodes 130 are backhaul interfaces 128 (e.g. S1 and/or NG interfaces).

Depending on the exact deployment scenario, the access nodes 120 may be RAN nodes such as NG-RAN nodes. NG-RAN nodes may be gNodeBs (gNBs) that provide NR user plane and control plane protocol terminations towards the UE. NG-RAN nodes may be New Generation Evolved Universal Terrestrial Radio Access network (E-UTRAN) NodeBs (ng-eNBs) that provide E-UTRA user plane and control plane protocol terminations towards the UE. The gNBs and ng-eNBs may be interconnected with each other by means of Xn interfaces. The gNBs and ng-eNBs are also connected by means of NG interfaces to the 5G Core (5GC), more specifically to the AMF (Access and Mobility management Function) by means of the NG-C interface and to the UPF (User Plane Function) by means of the NG-U interface. The access nodes 120 may be interconnected with each other by means of Xn interfaces 126. The cellular network 100 could be configured to operate in licensed or unlicensed frequency bands, not least such as a 60 GHz unlicensed band where beamforming is mandatory in order to achieve required coverage.

The access nodes 120 may be deployed in a NR standalone operation/scenario. The access nodes 120 may be deployed in a NR non-standalone operation/scenario. The access nodes may be deployed in a Carrier Aggregation, CA, operation/scenario. The access nodes 120 may be deployed in a dual connectivity operation/scenario, i.e. Multi Radio Access Technology-Dual Connection (MR-DC), not least for example such as:
Evolved Universal Terrestrial Radio Access-New Radio Dual Connectivity (EUTRA-NR-DC, also referred to as EN-DC),
New Radio-Evolved Universal Terrestrial Radio Access Dual Connectivity (NR-EUTRA-DC, also referred to as NE-DC),
Next Generation Radio Access Network Evolved Universal Terrestrial Radio Access-New Radio Dual Connectivity (NG-RAN E-UTRA-NR Dual Connectivity, also referred to as NGEN-DC), or
New Radio Dual Connectivity (also referred to as NR-DC).

In such non-standalone/dual connectivity deployments, the access nodes 120 may be interconnected to each other by means of X2 or Xn interfaces, and connected to an Evolved Packet Core (EPC) by means of an S1 interface or to the 5GC by means of a NG interface.

The terminal nodes 110 are network elements in the network that terminate the user side of the radio link. They are devices allowing access to network services. The terminal nodes 110 may be referred to as User Equipment (UE), mobile terminals or mobile stations. The term ‘User Equipment’ may be used to designate mobile equipment comprising a smart card for authentication/encryption etc such as a subscriber identity module (SIM). In other examples, the term ‘User Equipment’ is used to designate mobile equipment comprising circuitry embedded as part of the user equipment for authentication/encryption such as software SIM.

The access nodes 120 are network elements in the network responsible for radio transmission and reception in one or more cells 122 to or from the terminal nodes 110. Such access nodes may also be referred to as a transmission reception points (TRP's) or base stations. The access nodes 120 are the network termination of a radio link. An access node 120 may be implemented as a single network equipment, or disaggregated/distributed over two or more RAN nodes, such as a central unit (CU), a distributed unit (DU), a remote radio head-end (RRH), using different functional-split architectures and different interfaces.

In the following description, an access node will be referred to as gNB 120 and a terminal node 110 will be referred to as a UE 110.

In sub-7 GHz unlicensed bands/unlicensed spectrum, New Radio, NR, coexistence with other systems (e.g. IEEE 802.11) is ensured via a Listen Before Talk, LBT, channel access procedure/mechanism. In this, a User Equipment intending to perform a SideLink (SL) transmission needs first to complete successfully an LBT check before being able to initiate the transmission.

For a UE to pass an LBT check then it must observe the transmission channel as being available for a number of consecutive Clear Channel Assessment, CCA, slots. In sub-7 GHz, the duration of these slots is 9 μs. The UE deems the channel as being available in a CCA slot if the measured power (i.e. the collected energy during the CCA slot) is below a regulatory specified threshold (which may depend on the operating band and geographical region).

When a UE initiates the communication (i.e. the UE takes the role of initiating device), then the UE has to acquire the “right” to access the channel for a certain period of time-denoted as a Channel Occupancy Time, COT—by applying an “extended” LBT procedure. In this, the channel must be deemed as free for the entire duration of a backoff procedure determined by a Contention Window, CW. This “extended” LBT procedure, is commonly known as LBT Type 1 as specified in TS 37.213.

The duration of both the COT and CW depends on a Channel Access Priority Class, CAPC, associated with the UE's traffic, such as is shown in Table 1 below. Control plane traffic is transmitted with p=1, while user plane traffic has p>1.

TABLE 1
(from TS 37.213 “Table 4.2.1-1: Channel Access Priority Class (CAPC)
for UL”). The contention window length in CCA slots associated
with each CAPC has a minimum (CW_{min, p}) and maximum
(CW_{max, p}). The duration of the COT is given by T_{ulm cot, p}.

| Channel | | | | | |
|---|---|---|---|---|---|
| Access | | | | | |
| Priority | | | | | |
| Class, CAPC | | | | | |
| (p) | mₚ | CW_{min,} [symbol] | CW_{max, p} | T_{ulm cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, 255, 511, |
| | | | | | 1023} |
| 4 | 7 | 15 | 1023 | 6 ms or 10 ms | {15, 31, 63, 127, 255, 511, |
| | | | | | 1023} |

NOTE 1:
For p = 3, 4, T_{ulm cot, p} = 10 ms if the higher layer parameter absenceOfAnyOtherTechnology-r14 or absence OfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap shall be 100 us. The maximum duration before including any such gap shall be 6 ms. [symbol]
indicates data missing or illegible when filed

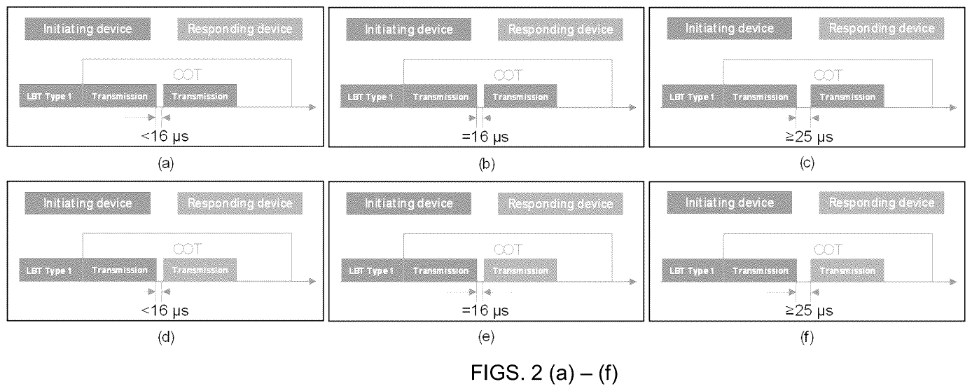

FIGS. 2(a)-(f) depicts LBT Type 1 details for a Uu UpLink, UL, case. It is to be appreciated that a Downlink, DL, case LBT Type 1 parameters could also in principle be adopted in SL. These FIGS illustrate the allowed gaps for which LBT Type 2 variants are applicable:
FIGS. 2(a) and (d)—LBT Type 2C;
FIGS. 2(b) and (e)—LBT Type 2B;
FIGS. 2(c) and (f)—LBT Type 2A.

FIGS. 2(a),(b). and (c) show the case where the gap is between the two transmissions both from the initiating UE, while (d), (e), and (f) show the case that the gap is between the two different transmissions from the initiating UE and the responder correspondingly.

The UE initiating the transmission (the initiating device), upon successfully completing the LBT Type 1 and performing a transmission, acquires a COT with a duration associated with a corresponding CAPC for the transmission. The acquired COT is valid even in the case where the initiating device pauses its transmission, although if the initiating device wants to perform a new transmission (within the COT) it is still required to perform a “reduced” LBT procedure. This “reduced” LBT procedure, is commonly known as LBT Type 2 [TS 37.213], with the following variants:

Type 2A (25 μs LBT)—for SL transmissions within the initiating device acquired COT (in case the gap between two SL transmissions is ≥25 μs, as well for SL transmissions following another SL transmission), depicted in FIGS. 2(c) and (f).

Type 2B (16 μs LBT)—for SL transmission within the initiating device acquired COT (may only be used for SL transmissions following another SL with gap exactly equal to 16 μs), depicted in FIGS. 2(b) and (e).

Type 2C (no LBT)—may only be used for SL transmission following another SL, with a gap <16 μs and the allowed duration of the SL transmission≤584 μs), depicted in FIGS. 2 (a) and (d).

The initiating device may share its acquired COT with its intended receiver (the responding device). For this purpose, the initiating device must inform (e.g. via control signaling) the responding device about the duration of this COT. The responding device uses then this information to decide which type of LBT it should apply upon performing a transmission for which the intended receiver is the initiating device. In case the responding device transmission falls outside the COT, then the responding device will have to acquire a new COT using the LBT Type 1 with the appropriate CAPC.

There now follows an overview of sidelink, SL, in New Radio, NR.

NR SL has been designed, in 3GPP Rel-16, to facilitate a UE to communicate with other nearby UE(s) via direct/SL communication. Two resource allocation modes have been specified, and an SL transmitter, Tx, UE is configured with one of them to perform its NR SL transmissions. These modes are denoted as: NR SL mode 1 and NR SL mode 2.

In NL SR mode 1, a sidelink transmission resource is assigned (scheduled) by the network, NW, to the SL Tx UE. Whereas an SL Tx UE in mode 2 autonomously selects its SL transmission resources.

In NL SR mode 1, where the gNB is responsible for the SL resource allocation, the configuration and operation is similar to that done over the Uu interface (which is depicted in FIG. 3). The MAC level details of this procedure are given in section 5.8.3 of TS 38.321.

In NL SR mode 2, which is depicted in FIG. 4, the SL UEs autonomously perform the resource selection with the aid of a sensing procedure. More specifically, an SL Tx UE in NR SL mode 2 first performs a sensing procedure over configured SL transmission resource pool(s), in order to obtain knowledge of resource(s) reserved by other nearby SL Tx UE(s). Based on the knowledge obtained from the sensing, the SL Tx UE may select resource(s) from the available SL resources, accordingly. In order for an SL UE to perform sensing and obtain the necessary information to receive an SL transmission, it needs to decode Sidelink Control Information, SCI. In release 16, the SCI associated with a data transmission includes a 1^{st}-stage SCI and 2^{nd}-stage SCI, and their contents are standardized in 3GPP TS 38.212.

The SCI follows a 2-stage SCI structure, whose main motivation is to support size differences between SCIs for various NR−V2X (NR-vehicle to everything) SL service types (e.g. broadcast, groupcast and unicast).

The 1^{st}-stage SCI, SCI format 1-A, is carried by Physical Sidelink Shared Channel, PSSCH, and contains:
information to enable sensing operations, and
information needed to determine resource allocation of the PSSCH and to decode 2^{nd}-stage SCI.

As per Rel-16, the contents of the 1^{st}-stage SCI are the following:

```
From 38.212:
8.3.1.1 SCI format 1-A
SCI format 1-A is used for the scheduling of PSSCH and 2^{nd}-stage-SCI on PSSCH.
The following information is transmitted by means of the SCI format 1-A:
  Priority - 3 bits as defined in clause 5.4.3.3 of [12, TS 23.287].
  $Frequency resource assignment - ⌈ {log}_{2} ( \frac{{N}_{subChannel}^{SL} ( {N}_{subChannel}^{SL} + 1 )}{2} ) ⌉ bits when the value$
of the higher layer parameter sl-MaxNumPerReserve is configured to 2; otherwise
$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ bits when the value of the higher layer parameter$
sl-MaxNumPerReserve is configured to 3, as defined in clause 8.1.2.2 of [6, TS 38.214].
  Time resource assignment - 5 bits when the value of the higher layer parameter sl-
MaxNumPerReserve is configured to 2; otherwise 9 bits when the value of the higher layer
parameter sl-MaxNumPerReserve is configured to 3, as defined in clause 8.1.2.1 of [6, TS 38.214].
  Resource reservation period -┌log₂ Nᵣₛᵥ_period┐ bits as defined in clause 8.1.4 of [6, TS 38.214],
where Nᵣₛᵥ_period is the number of entries in the higher layer parameter sl-ResourceReservePeriodList,
if higher layer parameter sl-MultiReserveResource is configured;
0 bit otherwise.
  DMRS pattern - ┌log₂ Nₚₐₜₜₑᵣₙ┐ bits as defined in clause 8.4.1.1.2 of [4, TS 38.211], where
Nₚₐₜₜₑᵣₙ is the number of DMRS patterns configured by higher layer parameter sl-
PSSCH-DMRS-TimePatternList; 0 bit if sl-PSSCH-DMRS-TimePatternList is not configured.
  2^{nd}-stage SCI format - 2 bits as defined in Table 8.3.1.1-1.
  Beta_offset indicator - 2 bits as provided by higher layer parameter sl-BetaOffsets2ndSCI
and Table 8.3.1.1-2.
  Number of DMRS port - 1 bit as defined in Table 8.3.1.1-3.
  Modulation and Coding Scheme, MCS - 5 bits as defined in clause 8.1.3 of [6, TS 38.214].
  Additional MCS table indicator - as defined in clause 8.1.3.1 of [6, TS 38.214]: 1 bit if
one MCS table is configured by higher layer parameter sl-Additional-MCS-Table; 2 bits if two
MCS tables are configured by higher layer parameter sl- Additional-MCS-Table; 0 bit otherwise.
  PSFCH overhead indication - 1 bit as defined clause 8.1.3.2 of [6, TS 38.214] if higher
layer parameter sl-PSFCH-Period = 2 or 4; 0 bit otherwise.
  Reserved - a number of bits as determined by higher layer parameter sl-NumReservedBits,
with value set to zero.
Table 8.3.1.1-1: 2^{nd}-stage SCI formats
```

| Value of 2nd-stage SCI | |
|---|---|
| format field | 2nd-stage SCI format |
| 00 | SCI format 2-A |
| 01 | SCI format 2-B |
| 10 | Reserved |
| 11 | Reserved |

The 2^{nd} stage SCI, SCI format 2-A and 2-B, carried by PSSCH (multiplexed with SL-SCH) and contains:
Source and destination identities;
information to identify and decode the associated SL-SCH Transfer Block, TB;
control of Hybrid Automatic Repeat Request, HARQ, feedback in unicast/groupcast;
trigger for CSI feedback in unicast,

As per Rel-16, the contents of the 2^{nd}-stage SCI are provided in Table 2 below:

| SCI Format 2-A | SCI Format 2-B |
|---|---|
| HARQ process number—4 bits. | HARQ process number—4 bits. |
| New data indicator—1 bit. | New data indicator—1 bit. |
| Redundancy version—2 bits as | Redundancy version—2 bits as |
| defined in Table 7.3.1.1.1-2. | defined in Table 7.3.1.1.1-2. |
| Source ID—8 bits as defined in | Source ID—8 bits as defined in clause |
| clause 8.1 of [6, TS 38.214]. | 8.1 of [6, TS 38.214]. |
| Destination ID—16 bits as defined in | Destination ID—16 bits as defined in |
| clause 8.1 of [6, TS 38.214]. | clause 8.1 of [6, TS 38.214]. |
| HARQ feedback enabled/disabled | HARQ feedback enabled/disabled |
| indicator—1 bit as defined in clause 16.3 of | indicator—1 bit as defined in clause |
| [5, TS 38.213]. | 16.3 of [5, TS 38.213]. |
| Cast type indicator—2 bits as defined | Zone ID—12 bits as defined in clause |
| in Table 8.4.1.1-1 and in clause 8.1 of [6, TS | 5.8.11 of [9, TS 38.331]. |
| 38.214]. | Communication range requirement—4 |
| CSI request—1 bit as defined in | bits determined by higher layer parameter |
| clause 8.2.1 of [6, TS 38.214] and in clause | sl-ZoneConfigMCR-Index. |
| 8.1 of [6, TS 38.214]. | |

There now follows an overview of SL physical layer structure.

The configuration of resources in a sidelink resource pool defines the minimum information required for a RX UE to be able to decode a transmission, which includes: the number of sub-channels; the number of Physical Resource Blocks, PRBs, per sub-channels; the number of symbols in a Physical Sidelink Control Channel, PSCCH; which slots have a PSFCH as well as other configuration aspects not relevant to the present disclosure.

The details of the actual sidelink transmission (i.e. the payload) is provided in the PSCCH (1^{st}-stage SCI) for each individual transmission, which includes: the time and frequency resources; the Demodulation Reference Signals, DMRS, configuration of the PSSCH; the MCS; PSFCH; among others.

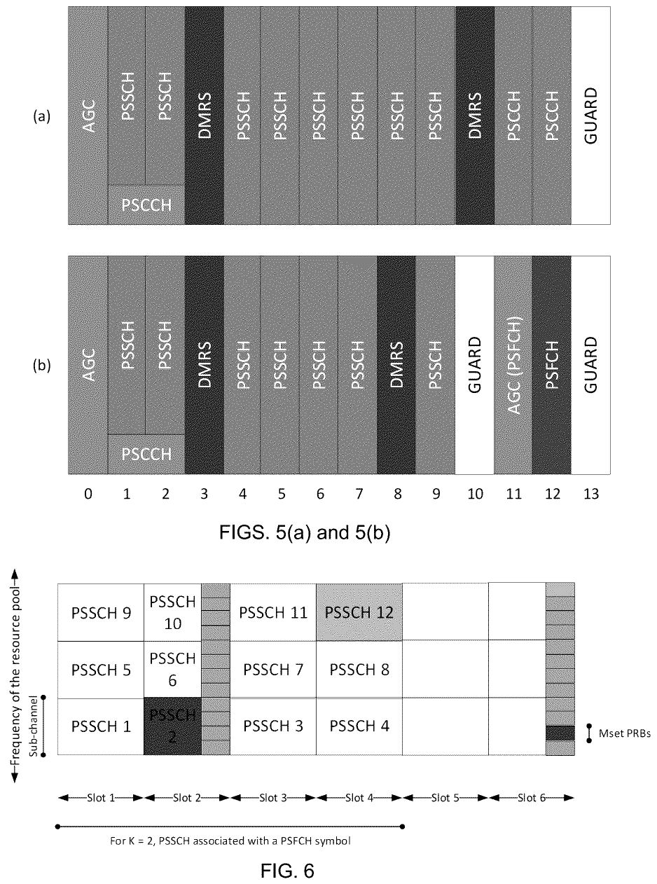

FIG. 5(a) schematically illustrates an example of an SL slot structure comprising a slot with PSCCH/PSSCH. FIG. 5(b) schematically illustrates an example of an SL slot structure comprising a slot with PSCCH/PSSCH and wherein the last symbols are used for PSFCH.

The configuration of the PSCCH (e.g. DMRS, MCS, number of symbols used) is part of the resource pool configuration. Furthermore, the indication of which slots have PSFCH symbols is also part of the resource pool configuration. However, the configuration of the PSSCH (e.g. the number of symbols used, the DMRS pattern and the MCS) is provided by the 1^{st}-stage SCI which is the payload sent within the PSCCH and follows the configuration depicted above and set out in 8.3.1.1 of Rel-16 TS 38.212.

There now follows an overview of SL HARQ operation.

The PSFCH was introduced during Rel-16 to enable HARQ feedback over the sidelink from a UE that is the intended recipient of a PSSCH transmission (i.e. the RX UE) to the UE that performed the transmission (i.e. the Tx UE). Within a PSFCH, a Zadoff-Chu sequence in one PRB is repeated over two OFDM symbols, the first of which may be used for AGC, near the end of the sidelink resource in a slot. An example slot format of PSCCH, PSSCH, and PSFCH is provided in FIG. 5(b). The Zadoff-Chu sequence as base sequence is (pre-) configured per sidelink resource pool.

The time resources for PSFCH are (pre-) configured to occur once every 0, 1, 2, or 4 slots according to 38.331. The HARQ feedback resource (PSFCH) is derived from the resource location of PSCCH/PSSCH.

For PSSCH-to-HARQ timing, there is a configuration parameter K with the unit of slot. The time occasion for PSFCH is determined from K. For a PSSCH transmission with its last symbol in slot n, HARQ feedback is in slot n+a where a is the smallest integer larger than or equal to K with the condition that slot n+a contains PSFCH resources. The time gap of at least K slots allows considering the RX UE's processing delay in decoding the PSCCH and generating the HARQ feedback. K may be equal to 2 or 3, and a single value of K may be (pre-) configured per resource pool. This allows several RX UEs using the same resource pool to utilize the same mapping of PSFCH resource(s) for the HARQ feedback. With the parameter K, the N PSSCH slots associated with a slot with PSFCH may be determined.

As an example, illustrated in FIG. 6, the period of PSFCH resources is configured as N=4 (i.e. there will be 4 PSSCH slots associated with the PSFCH), and K (the sl-MinTimeGapPSFCH which is the minimum time gap between PSFCH and the associated PSSCH in the unit of slots) is configured as 2. With L sub-channels in a resource pool and N PSSCH slots associated with a slot containing PSFCH, there are then N*L sub-channels associated with a PSFCH symbol. With M PRBs available for PSFCH in a PSFCH symbol, there are M PRBs available for the HARQ feedback of transmissions over N*L sub-channels.

With M configured to be a multiple of N*L, then a distinct set of Mset=M/(N*L) PRBs may be associated with the HARQ feedback for each sub-channel within a PSFCH period. The first set of Mset PRBs among the M PRBs available for PSFCH are associated with the HARQ feedback of a transmission in the first sub-channel in the first slot. The second set of Mset PRBs are associated with the HARQ feedback of a transmission in the first sub-channel in the second slot and so on.

This is illustrated in FIG. 6, with N=4, L=3 and with all PRBs in a PSFCH symbol available for PSFCH. In this example, the HARQ feedback for a transmission at PSSCH x is sent on the set x of Mset PRBs in the corresponding PSFCH symbol, with x=1, . . . , 12.

A set of Mₛₑₜ PRBs associated with a sub-channel are shared among multiple RX UEs in case of ACK/NACK feedback for groupcast communications (option 2) or in the case of different PSSCH transmissions in the same sub-channel.

For each PRB available for PSFCH, there are Q cyclic shift pairs available to support the ACK or NACK feedback of Q RX UEs within the PRB. For a resource pool, the number of cyclic shift pairs Q is (pre-) configured and may be equal to 1, 2, 3 or 6.

One may compute the number F of PSFCH resources available for supporting the HARQ feedback of a given transmission (in TS 38.213, F is denoted as

$${R}_{PRB , CS}^{PSFCH} ) .$$

With each PSFCH resource used by one RX UE,F available PSFCH resources may be used for the ACK/NACK feedback of up to F RX UEs.

The F PSFCH resources available for multiplexing the HARQ feedback for the PSSCH may be determined based on two options:
a) either based on the L PSSCH sub-channels used by a PSSCH, where the F may be computed as:
   F=L PSSCH*Mₛₑₜ*Q PSFCHs (associated with the L PSSCH sub-channels of a PSSCH)
   Where:
      L PSSCH sub-channels of a PSSCH;
      Mₛₑₜ PRBs for PSFCH associated with each sub-channel; and
      Q cyclic shift pairs available in each PRB.
b) or based only on the starting sub-channel used by a PSSCH (i.e. based only on one sub-channel for the case when L PSSCH>1).
   F=Mₛₑₜ*Q PSFCHs (associated with the starting sub-channel of a PSSCH)
   Where:
      Mₛₑₜ PRBs for PSFCH associated with each sub-channel; and
      Q cyclic shift pairs available in each PRB.

Similarly to the Physical Uplink Control Channel, PUCCH, in Rel. 15 NR Uu, the available F PSFCH resources are indexed based on a PRB index (frequency domain) and a cyclic shift pair index (code domain).

The mapping of the PSFCH index i (i=1, 2, . . . ,F) to the PRBs and to the Q cyclic shift pairs is such that the PSFCH index i first increases with the PRB index until reaching the number of available PRBs for PSFCH. Then, it increases with the cyclic shift pair index, again with the PRB index and so on.

Among the F PSFCHs available for the HARQ feedback of a given transmission, an RX UE selects for its HARQ feedback the PSFCH with index i given by:

i=(T_{ID}+R_{ID})mod F

where T_{ID} is the Layer 1 ID of the Tx UE (indicated in the 2^{nd}-stage SCI). R_{ID}=0 for unicast ACK/NACK feedback and groupcast NACK-only feedback (option 1).

For groupcast ACK/NACK feedback (option 2), RID is equal to the RX UE identifier within the group, which is indicated by higher layers. For a number X of RX UEs within a group, the RX UE identifier is an integer between 0 and X-1. An RX UE determines which PRB and cyclic shift pair should be used for sending its HARQ feedback based on the PSFCH index i. The RX UE uses the first or second cyclic shift from the cyclic shift pair associated with the selected PSFCH index i in order to send NACK or ACK, respectively.

By RX UEs selecting PSFCHs with index i a Tx UE may distinguish the HARQ feedback of different RX UE(s) (via the RX UE identifier, e.g. for groupcast option 2) and the HARQ feedback intended for the Tx UE (via the Layer 1 ID of the Tx UE, e.g. for unicast). As R_{ID}=0 for groupcast option 1, the RX UEs select the same PSFCH index i for their NACK-only feedback based solely on the Layer 1 ID Tx UE identifier TID.

The prioritization of simultaneous PSFCH transmission/reception is specified in TS 38.213. For a PSFCH transmission or reception with HARQ-ACK information, a priority value for the PSFCH is equal to the priority value indicated by an SCI format 1-A associated with the PSFCH.

For PSFCH transmission with conflict information, a priority value for the PSFCH is equal to the smallest priority value determined by the corresponding SCI formats 1-A for the conflicting resources.

For PSFCH reception with conflict information, a priority value for the PSFCH is equal to the priority value determined by the corresponding SCI format 1-A for the conflicting resource.

Currently, it is still open in SL-U design as to how to associate the channel access priorities for the respective SL channels' transmissions.

A basic problem to be addressed for PSFCH transmission by an SL-U UE without an initiated-COT is: Which CAPC should be used for the LBT of PSFCH transmission?

Various examples of the present disclosure seek to enable a determination of the CAPC for PSFCH that considers both coexistence fairness with other devices and channel access chance of transmitting PSFCH.

In various examples of the present disclosure, an SL Rx UE may select an appropriate CAPC for a PSFCH transmission, from a first CAPC and a second CAPC, taking into account an outcome of LBT for at least one recent PSFCH transmission(s).

The SL Rx UE may determine the first CAPC and the second CAPC at least using any combination of the followings:
The first CAPC may be pre-defined or configured with a higher p value for channel access of transmitting PSFCH than the second CAPC
   In an example, the first CAPC may be pre-defined/configured with a high p value (e.g. p=4) and the second CAPC may be pre-defined/configured with a low p value (e.g. p=1).
The first/second CAPC may be determined based on the priorities of the SL transmissions associated with the PSFCH for the SL Rx UE
   In an example, the first CAPC and second CAPC may be determined based on the lowest priority and highest priority of the SL transmissions associated with the PSFCH, respectively.

Optionally, if the p value of the second CAPC is not lower than the first CAPC or not lower than an offset amount with respect to the first CAPC, the second CAPC may be upgraded to a CAPC with a lower p value, i.e. p_{2nd}=max {1, p₁ₛₜ−p_{offset}} where the offset poffset may be pre-defined during standardization or configured to the SL Rx UE.

In another example, the first CAPC may be determined based on the highest priority (or the lowest priority) of the SL transmissions associated with the PSFCH whilst the second CAPC may be configured with a lower p value than the first CAPC where the p value of the second CAPC may be set to a certain value (i.e. p=1) by default, or be configured lower than an offset than that of the first CAPC (but is not less than the minimum p value), i.e. p_{2nd}=max {1, p₁ₛₜ−p_{offset}} where the offset p_{offset} may be pre-defined during standardization or configured to the SL Rx UE.

In some examples, the SL UE may obtain a priority of SL transmission through detecting a first stage SCI of an SL transmission and associate a PSFCH with the SL transmission based on the (pre) configured PSSCH-to-PSFCH timing.

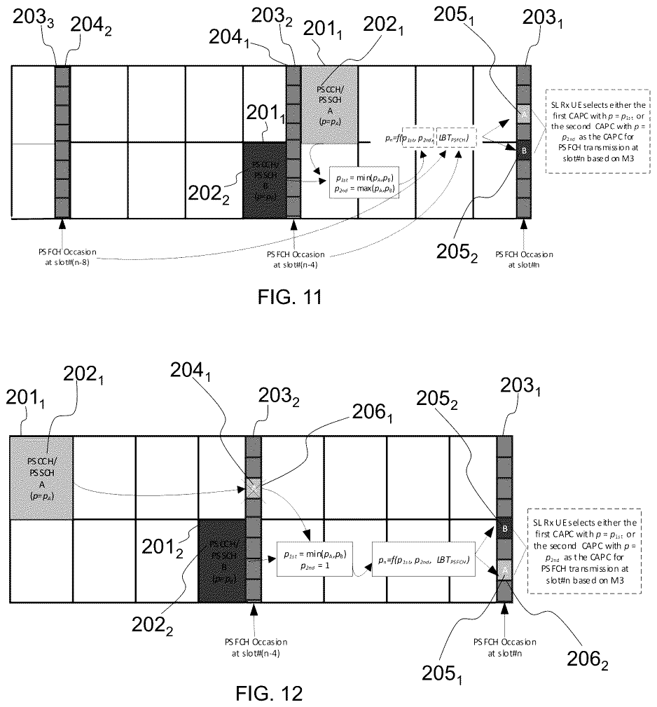

The SL UE may select either the first CAPC or the second CAPC for PSFCH transmission based on certain selection criteria/metrics where each selection criterion/metric may be designed based on the channel access status of the last PSFCH transmission(s). For instance, by default the SL UE may use the first CAPC for PSFCH transmission, but it shall select the second CAPC for PSFCH transmission if at least one of following conditions is satisfied:
a resource allocated for the PSFCH transmission is a secondary PSFCH resource for re-transmission of HARQ-ACK(s) that could not be transmitted on a primary PSFCH resource when intended due to failed LBT (e.g. see FIG. 12). Herein, if HARQ-ACKs on PSFCH could not be transmitted on a primary PSFCH resource when intended due to failed LBT, it is assumed that the secondary PSFCH resource will be configured to re-transmit the HARQ-ACK(s).
the LBT success rate of last x PSFCH transmissions is lower than y %
the number of LBT successes of the last x PSFCH transmissions is lower than y LBT successes (e.g. see FIG. 11)

Alternatively, the x PSFCH transmissions may correspond to a same HARQ process, which means the SL Rx UE may increase the channel access priority for PSFCH of re-transmissions.

Note that the value of x and y may be pre-defined in the specification or be pre-configured by the network.

Advantageously, examples of the present disclosure may enable CAPC selection for PSFCH based on channel access status of recent PSFCH transmission(s) so as to make a better trade-off between channel access opportunity for PSFCH and coexistence fairness with other devices. Examples may allow an upgrade to a CAPC with a higher channel access priority to improve channel access chance for PSFCH transmission if HARQ-ACK feedback is blocked due to an LBT failure in previous PSFCH transmission(s).

In some examples of the disclosure, the SL Rx UE may generally select a suitable channel access priority based on the lowest priority of the associated SL transmissions-like legacy NR-U UE for PDSCH/PUSCH transmission instead of the highest priority (of the associated SL transmissions) to ensure coexistence fairness with other devices. Only if the channel access success rate were low or LBT failure occurred for PSFCH transmission, would the SL Rx UE upgrade its CAPC for (re) transmission of HARQ ACK/NACK to improve the channel access chance for the SL Rx UE.

As examples of the disclosure may enable an SL Rx UE to conditionally upgrade the CAPC for PSFCH transmission, examples may thereby make a better tradeoff between the channel access opportunity of PSFCH and coexistence fairness with other devices.

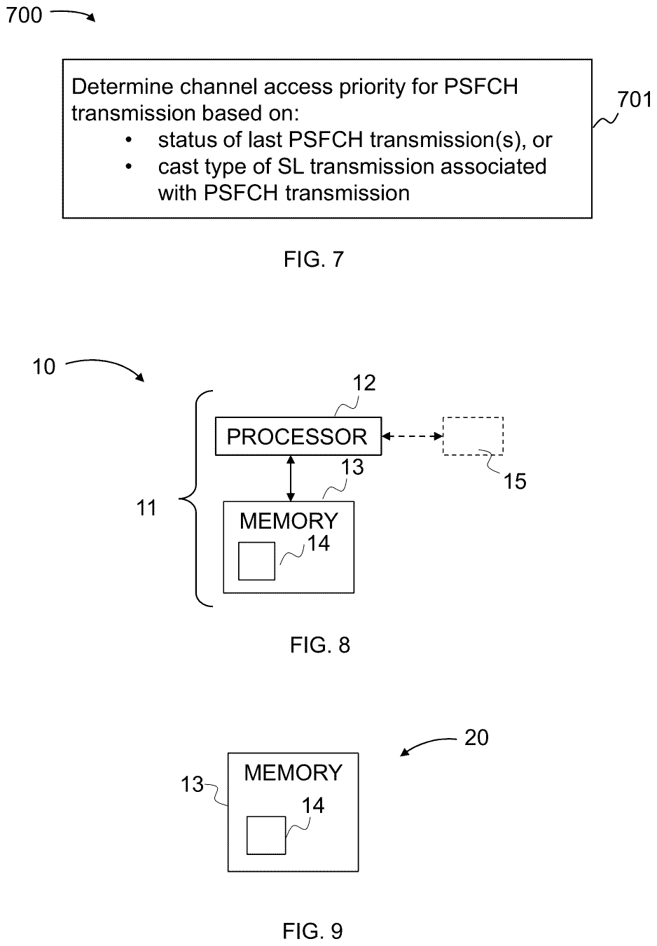

FIG. 7 schematically illustrates an example of a method 700 of the present disclosure. One or more of the features discussed in relation to FIG. 7 may be found in one or more of the other FIGS. During discussion of FIG. 7, use will be made of reference numerals of features shown in other FIGS (not least FIGS. 11 and 12) for the purposes of explanation.

The method of FIG. 7, as well as the functions described below may represent actions in a method, functionality performed by an apparatus, and/or sections of instructions/code in a computer program. It will be understood that the functionality described below may be implemented by various means, such as hardware, firmware, and/or software including one or more computer program instructions. For example, one or more of the functions described below may be performed by a duly configured apparatus (such as a UE, for instance an SL Rx UE, comprising means for performing the below described functions). One or more of the functions described below may be embodied by a duly configured computer program (such as a computer program comprising computer program instructions which embody the functions described below and which may be stored by a memory storage device and performed by a processor).

The method of FIG. 7, as well as the functions described below, may be performed by/at a single physical entity, such as an apparatus as described with reference to FIG. 8. The functions described may also be implemented by a computer program, such as is described with reference to FIG. 9.

In block 701, information indicative of a channel access priority (p) for a transmission (205) over a transmission channel (203) is determined based at least in part on at least one of:
information indicative of a status of at least one previous transmission (204) over the transmission channel (203); and
information indicative of a cast type of a received transmission (202) that is associated with the transmission (205).

For the purposes of the following discussion of various examples of the disclosure and for simplicity of explanation:
the transmission channel may be referred to as a physical sidelink feedback channel, PSFCH;
the transmission may be referred to as a PSFCH transmission, e.g. a current/upcoming PSFCH transmission or PSFCH occurrence; and
the at least one previous transmission may be referred to: as at least one previous or recent PSFCH transmission, a last at least one PSFCH transmission, or a last at least one PSFCH occurrence. It may also be referred to as a last x number of PSFCH transmission(s) where x is an integer >0. The term “last” as used herein may refer to “immediately preceding” or most recent, e.g. the last x PSFCH transmissions may refer to the previous two PSFCH occasions immediately preceding a current current/upcoming PSFCH occasion (wherein a channel access priority is to be determined for the current/upcoming PSFCH transmission being the PSFCH transmission for which a channel access priority is to be determined).

It is to be appreciated that the underlying concept of the present disclosure may be applicable to a transmission channel other than PSFCH, a transmission other than a PSFCH transmission, and at least one previous transmission other than at least one previous PSFCH transmission. For instance, in some examples, the transmission channel is at least one selected from the group of:
a physical sidelink shared channel, PSSCH; and
a synchronization signal block, SSB.

In some examples, the transmission channel is in an unlicensed band.

In some examples, the information indicative of a channel access priority is indicative of at least one selected from the group of:
a priority class for use in a procedure for determining whether a transmitting device (e.g. an SL Rx UE) is permitted to transmit over the transmission channel, not least such as a Listen Before Talk, LBT, procedure;
a priority class for use in an unlicensed band;
a Channel Access Priority Class, CAPC;
a Contention Window, CW (e.g. determined based not least in part in view of a determined CAPC and Table 1); and
a Channel Occupancy Time, COT (e.g. determined based not least in part in view of a determined CAPC and Table 1).

In some examples, the information indicative of a status of at least one previous transmission comprises information indicative of at least one selected from the group of:
a channel access status of the at least one previous transmission, such a status may be indicative of whether the at least one previous transmission failed or was successful;
whether an LBT procedure, for transmitting the at least one previous transmission, failed or was successful;
an LBT success rate for one or more previous transmissions;
a number of LBT successes for one or more previous transmissions;
whether the transmission comprises a re-transmission of information that failed to be successfully transmitted via the at least one previous transmission;
allocation of resources for the transmission (e.g. PSFCH resources for a PSFCH transmission, such as a HARQ feedback), wherein the resources are allocated for re-transmitting information that failed to be successfully transmitted via the at least one previous transmission (such resources may correspond to “secondary” resources that have been allocated, e.g. to an SL Rx UE, for effecting the transmission, following on from “primary” resources having been previously allocated to seek to previously transmit the transmission but wherein the previous transmission was unsuccessfully and thereby necessitating “secondary” resources to be allocated to re-transmit the previously failed transmission); and whether the PSFCH transmission is within a channel occupancy time, COT, shared by a UE (i.e. another UE). For example, if the SL Rx UE may detect a COT shared by a SL Tx UE, however the SL Rx UE is not a responder of the COT, it may be allowed to upgrade its CAPC for the PSFCH transmission.

In some examples, the information indicative of a status of at least one previous transmission is determined.

In some examples, determining information indicative of the channel access priority for the transmission comprises:
determining a first candidate priority class (p₁ₛₜ) for the transmission;
determining a second candidate priority class (p_{2nd}) for the transmission; and
selecting at least one of a first candidate priority class and a second candidate priority class. For instance, the information indicative of the channel access priority that is determined may be a priority class (p) and the determined priority class may correspond to the selected the first or second candidate priority class, i.e. p=p₁ₛₜ Or p_{2nd}, wherein one of the first or second candidate priority class is selected in accordance with one or more selection criterion/metrics as discussed below.

In some examples, the first and/or second candidate priority classes are pre-defined, for instance they may be set out in a standard such as a 3GPP Technical Specification, TS.

In some examples, the first and/or second candidate priority classes are configured to the apparatus. For instance, a gNB may determine the first and/or second candidate priority classes, e.g. based on the traffic information. The gNB may configure an SL Rx UE with the first and/or second candidate priority classes. By configuring the SL Rx UE with the first and/or second candidate priority classes, this reduces implementation complexity by avoiding the SL Rx UE needing to determine the first and/or second candidate priority classes for itself.

In some examples, the first candidate priority class is configured to have a lower priority (i.e. a higher p value/CAPC value) than a priority of the second candidate priority class, i.e. p₁ₛₜ>p_{2nd}.

In some examples, the first candidate priority class is determined based at least in part on a lowest channel access priority of one or more received SL transmissions associated with the transmission. For instance, the transmission may be a PSFCH transmission and the one or more received SL transmissions may be one or more PSCCH+PSSCH transmissions (e.g. PSCCH+PSSCH A, and PSCCH+PSSCH B) that are received by an SL Rx UE, wherein each of the one or more PSCCH+PSSCH transmissions is associated with its own channel access priority value (e.g. PA and PB), such as is indicated by an SCI format 1-A carried by the PSCCH. It is to be appreciated that the PSCCH+PSSCH transmissions are associated with the PSFCH transmission by virtue of the PSFCH transmission providing feedback (such as a HARQ feedback) for PSCCH+PSSCH transmissions. The first candidate priority class may be p₁ₛₜ=min(p_{A}, p_{B}).

In some examples, the second candidate priority class is determined based at least in part on a highest channel access priority of one or more received SL transmissions associated with the transmission, i.e. be p_{2nd}=max (p_{A}, p_{B}).

In some examples, the second candidate priority class is determined based at least in part on the first candidate priority class. For instance, p_{2nd}=max{1,p₁ₛₜ−p_{offset}}, wherein p_{offset} is a property class offset parameter. The value of the offset parameter may be pre-defined during standardization or configured to the SL Rx UE. For instance, a priority class offset parameter value may be determined by a gNB, e.g. based on a channel access requirement of the SL Rx UE or traffic type, and the gNB may provide the priority class offset parameter value to the SL Rx UE such that the SL Rx UE may determine second candidate priority class. For example, having determined p₁ₛₜ, the SL Rx UE may determine p_{2nd} based on p_{2nd}=max {1,p₁ₛₜ−p_{offset}}.

In some examples, at least one of the first and second candidate priority classes is selected in accordance with at least one selection criterion.

In some examples, the at least one selection criterion comprises selecting the first candidate priority class by default.

In some examples, the at least one selection criterion comprises selecting the second candidate priority class in response to at least one of:
determining whether the transmission (e.g. PSFCH transmission) is a retransmission of at least a part of a previously attempted transmission (e.g. an earlier attempt at transmitting the same PSFCH transmission or at least a part thereof);
determining whether the transmission (e.g. PSFCH transmission) is a re-transmission of feedback (e.g. a Hybrid Automatic Repeat Request Acknowledgement, HARQ-ACK, or a Negative Acknowledgement, NACK) previously attempted to be transmitted;
determining a type of resource for the transmission (e.g. determining whether the transmission uses one or more “secondary” PSFCH resources for re-transmitting a PSFCH transmission that had previously attempted to be transmitted via “primary” PSFCH resources);
determining whether resources allocated for the transmission are resources allocated for re-transmitting information that failed to be successfully transmitted via the at least one previous transmission; and
determining whether a HARQ-ACK of one or more previous transmissions could not be transmitted via earlier allocated resources due to an LBT failure.

In some examples, the at least one selection criterion comprises selecting the second candidate priority class in response to determining whether an LBT success rate of a number (x) of previous transmissions is less than a threshold LBT success rate value (y %). The LBT success rate may be determined by the transmitting device performing the LBT procedure (e.g. the SL Rx UE) and each of the: number (x) of previous transmissions, and threshold LBT success rate (y %) could be pre-defined or configured to the SL Rx UE.

In some examples, the at least one selection criterion comprises selecting the second candidate priority class in response to determining whether a number of LBT successes of a number of previous transmissions (x) is less than a threshold value (y). Each of the threshold number of LBT successes (y) and number (x) of previous transmissions could be pre-defined or configured to the SL Rx UE, such that the SL Rx UE LBT may evaluate whether the number LBT successes in the last x previous transmissions is less than the threshold number of LBT successes (y).

In some examples, the at least one selection criterion comprises selecting the second candidate priority class in response to determining whether the received transmission is a unicast.

In some examples, configuration information and/or parameters is received for enabling the apparatus to determine the information indicative of a channel access priority for the transmission. For example, the SL Rx UE may be provided with one or more of:
a value of the first candidate priority class, p₁ₛₜ;
a value of the second candidate priority class, p_{2nd};
a value of the priority class offset parameter, p_{offset};
a threshold value of the LBT success rate (y %);
a threshold value of the number of LBT successes (y);
a value of the number (x) of previous transmissions; and
an indication as to a cast type of the received transmission associated with the transmission (e.g. whether it is unicast or groupcast).

In some examples, configuration information is received for enabling a determination of the at least one selection criterion that is to be applied (i.e. in order to select one of the first candidate priority class and the second candidate priority class).

In some examples, a determination is made to at least one selection criterion to apply based at least in part on a cast type of the received transmission that is associated with the transmission (e.g. whether the received SL transmission/PSSCH transmission associated with the PSFCH transmission is a unicast transmission to a single UE or groupcast transmission to a plurality of UEs).

In some examples, the received transmission that is associated with the transmission comprises a received PSSCH transmission that is associated with a PSFCH transmission.

In some examples, a channel access procedure for transmitting the transmission (e.g. LBT) is performed based at least in part on the determined information indicative of a channel access priority. For instance, the determined information indicative of a channel access priority may be a CAPC to be used in an LBT procedure for accessing a PSFCH to transmit a PSFCH transmission, wherein the CAPC is used to determine values of COT and CW to be used in the LBT procedure.

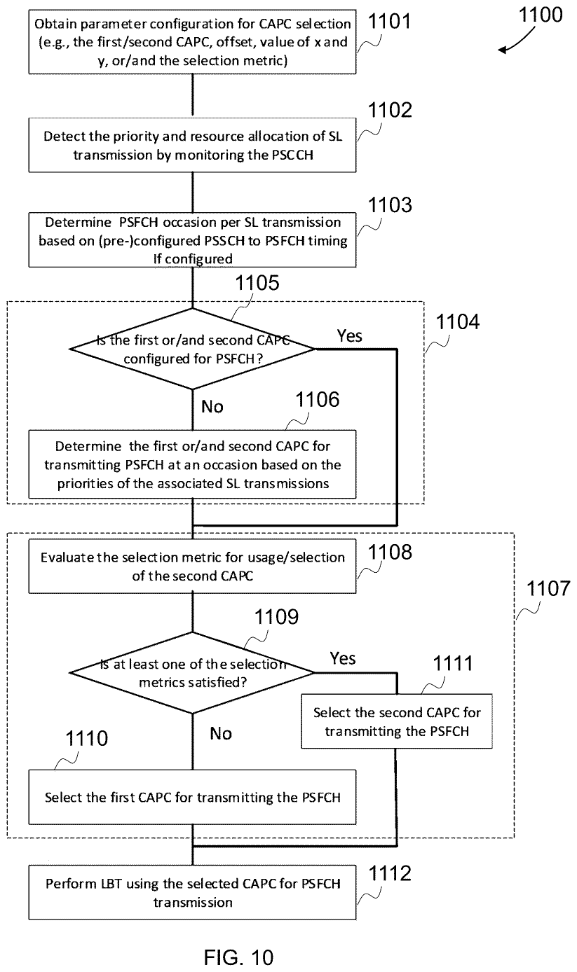

The functionality described above, not least following on from the description of FIG. 7 as well as the functionality discussed below with respect to FIGS. 10-12, may be implemented in hardware, software or a combination of hardware and software.

Various, but not necessarily all, examples of the present disclosure provide both a method and corresponding apparatus comprising various modules, means or circuitry that provide the functionality for performing/applying the actions of the method. The modules, means or circuitry may be implemented as hardware, or may be implemented as software or firmware to be performed by a computer processor. In the case of firmware or software, examples of the present disclosure may be provided as a computer program product including a computer readable storage structure embodying computer program instructions (i.e. the software or firmware) thereon for performing by the computer processor.

FIG. 8 schematically illustrates a block diagram of an apparatus 10 for performing the methods, processes, procedures and signalling described in the present disclosure, i.e. not least the functionality described above following on from the description of FIG. 7 as well as the functionality discussed below with respect to FIGS. 10-12.

The component blocks of FIG. 8 are functional and the functions described may be performed by a single physical entity.

The apparatus comprises a controller 11, which could be provided within a device such as a UE 110, for instance an SL Rx UE configured for receiving SL transmissions initiated by an SL Tx UE configured for initiating SL communication/transmissions.

The controller 11 may be embodied by a computing device, not least such as those mentioned above. In some, but not necessarily all examples, the apparatus may be embodied as a chip, chip set, circuitry or module, i.e. for use in any of the foregoing. As used here ‘module’ refers to a unit or apparatus that excludes certain parts/components that would be added by an end manufacturer or a user.

Implementation of the controller 11 may be as controller circuitry. The controller 11 may be implemented in hardware alone, have certain aspects in software including firmware alone or may be a combination of hardware and software (including firmware).

The controller 11 may be implemented using instructions that enable hardware functionality, for example, by using executable instructions of a computer program 14 in a general-purpose or special-purpose processor 12 that may be stored on a computer readable storage medium 13, for example memory, or disk etc, to be executed by such a processor 12.

The processor 12 is configured to read from and write to the memory 13. The processor 12 may also comprise an output interface via which data and/or commands are output by the processor 12 and an input interface via which data and/or commands are input to the processor 12. The apparatus may be coupled to or comprise one or more other components 15 (not least for example: a radio transceiver, sensors, input/output user interface elements and/or other modules/devices/components for inputting and outputting data/commands).

The memory 13 stores a computer program 14 comprising instructions (computer program instructions/code) that controls the operation of the apparatus 10 when loaded into the processor 12. The instructions of the computer program 14, provide the logic and routines that enables the apparatus to perform the methods, processes and procedures described in the present disclosure and illustrated in FIGS. 7 and 10-12. The processor 12 by reading the memory 13 is able to load and execute the computer program 14.

The computer program instructions may be comprised in a computer program, a non-transitory computer readable medium, a computer program product, a machine-readable medium. The term “non-transitory,” as used herein, is a limitation of the medium itself (i.e. tangible, not a signal) as opposed to a limitation on data storage persistency (e.g. RAM vs. ROM). In some but not necessarily all examples, the computer program instructions may be distributed over more than one computer program.

Although the memory 13 is illustrated as a single component/circuitry it may be implemented as one or more separate components/circuitry some or all of which may be integrated/removable and/or may provide permanent/semi-permanent/dynamic/cached storage.

Although the processor 12 is illustrated as a single component/circuitry it may be implemented as one or more separate components/circuitry some or all of which may be integrated/removable. The processor 12 may be a single core or multi-core processor.

The apparatus may include one or more components for effecting the methods, processes and procedures described in the present disclosure and illustrated in FIGS. 7 and 10-12. It is contemplated that the functions of these components may be combined in one or more components or performed by other components of equivalent functionality. The description of a function should additionally be considered to also disclose any means suitable for performing that function. Where a structural feature has been described, it may be replaced by means for performing one or more of the functions of the structural feature whether that function or those functions are explicitly or implicitly described.

Although examples of the apparatus have been described above in terms of comprising various components, it should be understood that the components may be embodied as or otherwise controlled by a corresponding controller or circuitry such as one or more processing elements or processors of the apparatus. In this regard, each of the components described above may be one or more of any device, means or circuitry embodied in hardware, software or a combination of hardware and software that is configured to perform the corresponding functions of the respective components as described above.

The apparatus may, for example, be a client device, a server device, a mobile cellular telephone, a base station in a mobile cellular telecommunication system, a wireless communications device, a hand-portable electronic device, a location/position tag, a hyper tag etc. The apparatus may be embodied by a computing device, not least such as those mentioned above. However, in some examples, the apparatus may be embodied as a chip, chip set, circuitry or module, i.e. for use in any of the foregoing.

In one example, the apparatus is embodied on a hand held portable electronic device, such as a mobile telephone, mobile communication device, wearable computing device or personal digital assistant, that may additionally provide one or more audio/text/video communication functions (for example tele-communication, video-communication, and/or text transmission (Short Message Service (SMS)/Multimedia Message Service (MMS)/emailing) functions), interactive/non-interactive viewing functions (for example web-browsing, navigation, TV/program viewing functions), music recording/playing functions (for example Moving Picture Experts Group-1 Audio Layer 3 (MP3) or other format and/or (frequency modulation/amplitude modulation) radio broadcast recording/playing), downloading/sending of data functions, image capture function (for example using a (for example in-built) digital camera), and gaming functions, or any combination thereof.

In some examples, the apparatus comprises:
at least one processor 12; and
at least one memory 13 storing instructions that, when executed by the at least one processor 12, cause the apparatus at least to:
   determining information indicative of a channel access priority for a physical sidelink feedback channel, PSFCH, transmission based at least in part on:
      information indicative of at least one status of a last at least one PSFCH transmission; or
      information indicative of a cast type of a sidelink, SL, transmission that is associated with the PSFCH transmission.

The above described apparatus may find application as an enabling component of: telecommunication devices, telecommunication systems; tracking systems, automotive systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things (IoT); Vehicle-to-everything (V2X), virtualized networks; and related software and services.

The apparatus may be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus may be provided in a mobile terminal, other types of electronic devices, such as, but not limited to: mobile communication devices, location tags, hand portable electronic devices, wearable computing devices, portable digital assistants (PDAs), pagers, mobile computers, desktop computers, televisions, gaming devices, laptop computers, cameras, video recorders, GPS devices and other types of electronic systems, may readily employ examples of the present disclosure. Furthermore, devices may readily employ examples of the present disclosure regardless of their intent to provide mobility.

Various, examples of the present disclosure may take the form of instructions of a computer program. Such computer program instructions may be provided to one or more processor(s), processing circuitry or controller(s) such that the instructions which execute on the same create means for causing implementing the functions discussed above, such that the method may be computer implemented.

FIG. 9, illustrates a computer program 14 which may be conveyed via a delivery mechanism 20. The delivery mechanism 20 may be any suitable delivery mechanism, for example, a machine-readable medium, a computer-readable medium, a non-transitory computer-readable storage medium, a computer program product, a memory device, a solid-state memory, a record medium such as a Compact Disc Read-Only Memory (CD-ROM) or a Digital Versatile Disc (DVD) or an article of manufacture that comprises or tangibly embodies the computer program 14. The delivery mechanism may be a signal configured to reliably transfer the computer program. An apparatus may receive, propagate or transmit the computer program as a computer data signal.

In certain examples of the present disclosure, there is provided a computer program comprising instructions, which when executed by an apparatus (e.g. apparatus 10 which could be implemented in a UE 110), cause the apparatus to perform at least the following or for causing performing at least the following:
determining information indicative of a channel access priority for a physical sidelink feedback channel, PSFCH, transmission based at least in part on:
   information indicative of at least one status of a last at least one PSFCH transmission; or
   information indicative of a cast type of a sidelink, SL, transmission that is associated with the PSFCH transmission.

References to ‘computer program’, ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry);
(b) combinations of hardware circuits and software, such as (as applicable):
   (i) a combination of analog and/or digital hardware circuit(s) with software/firmware, and
   (ii) any portions of hardware processor(s) with software (including digital signal processor(s)), software, and memory (ies) that work together to cause an apparatus, such as a mobile phone or server, to perform various functions; and
(c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

FIG. 10 shows a flow chart of method 1100 for selecting CAPC for PSFCH transmission. The method may be performed by a UE, such as an SL-U Rx UE (i.e. a UE in the role of a receiver of sidelink transmission in the unlicensed band from an SL-U Tx UE).

In block 1101, the SL Rx UE obtains parameter configuration information for CAPC selection. Such parameter configuration information may comprise one or more of the previously discussed parameters that are used in determining and applying a selection criterion/metric to apply and evaluating the selection criterion/metric. In the regard, the parameter configuration information may comprise:
a first candidate CAPC p₁ₛₜ,
a second candidate CAPC p_{2nd},
an offset p_{offset},
a threshold value of an LBT success rate (y %),
a threshold value of a number of LBT successes (y), and
a value of a number (x) of previous transmissions.

The network 100 and/or gNB 120 may determine the configuration information (such as the first and/or second CAPC, or the offset p_{offset}) for CPAC selection and configure the SL Rx UE with the same. The determination of the configuration information may be made taking into account, for example: implementation complexity, channel access opportunity and/or coexistence fairness among different RATs/devices.

In an implementation, to reduce UE implementation complexity, the first and/or second CAPC may be configured by the network and thus the SL Rx UE does not need to determine the CAPC (e.g. based on the traffic information).

In another implementation, to ensure coexistence fairness with other devices, the first CAPC may be configured with the highest CAPC (i.e. the lowest channel access priority, p=4). Whereas the second CAPC may be configured with the lowest CAPC (i.e. the highest channel access priority, p=1) to increase channel access opportunity, such as in the case of a HARQ-ACK/NACK retransmission or low channel access success rate.

In a further implementation, the offset p_{offset} between the second CAPC and the first CAPC may be determined based on a channel access requirement of UE or traffic type, for example, the offset p_{offset} may be set to a high/large value (e.g. 2) for Ultra-Reliable Low-Latency Communication, URLLC, otherwise it may be set to a low/small value (e.g. 1).

As discussed below with respect to block 1108, the values of the parameters (e.g. x and y) may be used in the section criteria/metric to determine whether the first CAPC or the second CAPC is selected for PSFCH transmission. The parameter values may be determined based on channel access requirement, e.g. the larger the value of y, the higher the channel access requirement; the larger the value of x, the longer the decision observation time.

In block 1101, one or more selection metrics may also be configured to the SL-U Rx UE for PSFCH transmission. The selection metric to be applied by the SL-U Rx EU may be based at least in part on: a channel access status (e.g. whether previous PSFCH transmissions have failed/been unsuccessful) or a UE type (e.g. URLLC UE) or a traffic type.

In some implementations, parameter configuration information may be pre-defined during specification, or be configured to the SL-U Rx UE by the network or via another SL UE.

In block 1102, the SL-U Rx UE monitors the PSCCH to determine a priority and resource allocation of an SL transmission from an SL-U Tx UE.

The priority may be determined based on traffic type and Quality of Service, QoS, such as defined in clause 5.4.3.3 of [12, TS 23.287]. The SL-U Rx UE may detect the priority and the resource allocation through the 1^{st}-stage SCI as discussed above.

In some implementations, the SL transmission may be limited to unicast or groupcast transmission towards the SL-U Rx UE. Such a determination of the cast type may be identified through detecting the cast type and the destination ID in the second stage SCI provided in Table 2.

In block 1103, the SL-U Rx UE determines a PSFCH occasion per SL transmission (i.e. PSSCH) based on configured PSSCH to PSFCH timing if HARQ-ACK feedback is anticipated for PSSCH by detecting a HARQ feedback enabled/disabled indicator in the second stage SCI provided in Table 2.

In some implementations, the SL-U RX UE may determine a frequency domain position of a PSFCH transmission for HARQ feedback of an SL transmission based on a lowest Physical Resource Block, PRB, index of a resource allocation for the SL transmission. The SL-U RX UE may also determine a time-domain position of a HARQ feedback based on pre-defined PSSCH to PSCCH timing for the SL transmission discussed above in the overview of SL HARQ operation.

In some implementations, a primary PSFCH occasion and a secondary PSFCH occasion may be configured for HARQ-ACK feedback associated with an SL transmission. If HARQ-ACK(s) may not be transmitted on the primary PSFCH occasion when intended, e.g. due to a failed LBT channel access procedure, the SL-U Rx UE may then seek to transmit (i.e. re-transmit) the HARQ-ACK(s) on the secondary PSFCH occasions.

In block 1104, the SL Rx UE determines a first candidate CAPC p₁ₛₜ and a second candidate CAPC p_{2nd} for PSFCH transmission.

In this regard, in block 1105, if the first and second candidate CAPCs are pre-defined or configured to the SL-U Rx UE, then the SL-U Rx UE uses the pre-defined/configured first and second candidate CAPCs. Otherwise, in block 1106, the SL-U Rx UE determines, based on the priority of the associated SL transmission, the first and/or second CAPCs for PSFCH transmission at a given occasion, such as in a manner as previously discussed.

In block 1107: the SL-U Rx UE selects one CAPC from the first candidate CAPC (p₁ₛₜ) and the second candidate CAPC (p_{2nd}) to use as the CAPC (p) for PSFCH transmission. The selection is based on one or more selection criteria/metrics.

In some implementations, the selection metric(s) to be applied by the SL-U Rx UE may be pre-defined or configured to the SL Rx UE.

In block 1108, the SL-U Rx UE evaluates the selection metric(s) to determine, in block 1109 if the selection metric has been satisfied and hence whether to select:
either the first candidate CAPC to use for PSFCH transmission, as per block 1110; or the second candidate CAPC to use for PSFCH transmission, as per block 1111.

In an implementation, the selection metrics may be implemented taking into account a channel access status of the last x number of PSFCH transmission(s).

By default, the SL-U Rx UE selects the first candidate CAPC for PSFCH transmission if the second CAPC is not selected based on anyone of the configured selection metrics as below.

The selection metrics may comprise:
Metric 1—M1: if a PSFCH resource is a “secondary” PSFCH resource (i.e. a PSFCH resource that has been allocated to the SL-U Rx UE for re-transmitting at least one HARQ-ACK(s) on the PSFCH that had previously, but unsuccessfully [e.g. due to failed LBT] attempted to be transmitted via a “primary” PSFCH resource), the SL Rx UE selects the second candidate CAPC.
In some instances, a first/primary PSFCH resource may use Type 2 channel access procedure if there is an available COT, while for a second/secondary PSFCH resource the UE may have to select a CAPC to initiate a Type 1 LBT procedure, for example, the second candidate CPAC in case there is no available COT.
Metric 2—M2: if a LBT success rate of the last x PSFCH transmissions is lower than a threshold success rate (y %), the SL-U Rx UE selects the second candidate CAPC. In an example, the value of x and y may be set to 2 and 50, respectively.
Metric 3—M3: if the number of LBT success for last x PSFCH transmissions is lower than y, the SL Rx UE selects the second candidate CAPC. In an example, the value of x and y may be set to 2 and 1, respectively.
Metric 4—M4: if the PSFCH transmission is within a COT initiated by another UE while the SL Rx UE is not the COT responder, the SL Rx UE selects the second candidate CAPC. The SL Rx UE may detect the COT information by monitoring the SCI of the another UE.

Following the selection of either the first or second candidate CAPC to be used as the CAPC for PSFCH transmission, the SL-U Rx UE determines channel access parameters based on the selected CAPC for PSFCH transmission. The channel access parameters may include a CW and/or a COT, which may be determined based on the selected CAPC and the information provided in Table 1.

Then, in block 1112, the Rx UE performs LBT (e.g. Type 1 LBT) with the determined channel access parameters, i.e. to seek to acquire the “right” to access the channel to transmit the PSFCH transmission.

FIG. 11 illustrates an example of determining a CAPC for PSFCH transmission in accordance with the present disclosure.

In this example, a sidelink resource 2011 is allocated to a sidelink transmission 202₁ PSCCH/PSSCH A at slot #(n-3) toward an SL Rx UE. A sidelink resource 2012 is allocated to a sidelink transmission 202₂ PSCCH/PSSCH B at slot #(n-4) toward the SL Rx UE.

Based on configured PSSCH-to-PSFCH timing, HARQ feedback 205₁ and 205₂ of the two PSSCHs 202₁ and 202₂ respectively is necessary for the SL Rx UE on the PSFCH 203 at slot #n.

If the first and second candidate CAPC values for a PSFCH transmission, p₁ₛₜ and p_{2nd} (referred to as first CAPC and second CAPC) are not pre-determined or configured to the SL Rx UE, the SL Rx UE determines p₁ₛₜ and p_{2nd} based on the priorities of the SL transmissions 202₁ and 202₂ that are associated with the PSFCH transmissions 205₁ and 205₂ over PSFCH 203, i.e. the SL Rx UE determines the priorities of: PSSCH A (=p_{A}) and PSSCH B (p_{B}).

In this example, the first candidate CAPC p₁ₛₜ is determined based on the lowest priority of the PSSCH A/B, i.e. p₁ₛₜ=min (p_{A}, p_{B}). The second candidate CAPC p_{2nd} is determined based on the highest priority of the PSSCH A/B, i.e. p_{2nd}=max (p_{A}, p_{B}).

In this example, the selection metric M3 is applied, i.e. the SL Rx UE selects a CAPC with p=pₙ for PSFCH transmission based on the selection metric M3, where pₙ is a function of the first candidate CAPC p₁ₛₜ, the second candidate CAPC p_{2nd} and an LBT status of previous PSFCH transmissions LBT_{PSFCH} 204₁ and 204₂ at slot #(n-4) and slot #(n-8), i.e.:

pₙ=f(p₁ₛₜ, p_{2nd}, LBT_{PSFCH}) (1)

In this particular example, the value of x (a number last PSFCH transmissions) is set to 2 and the value of y (a threshold number of LBT successes) is set to 1 for the selection metric M3.

Accordingly, if the LBT fails for previous PSFCH transmissions 204₁ and 204₂ at both slot #(n-4) and slot #(n-8), the SL Rx UE will select the second candidate CAPC for channel access procedure of PSFCH transmission at slot #n, i.e. the SL Rx UE will select p=p_{2nd}. Otherwise, the SL Rx UE will select the first candidate CAPC for channel access procedure of PSFCH transmission at slot #n. In other words, the SL Rx UE will select p=p₁ₛₜ if the LBT fails for PSFCH transmission at only one of the previous PSFCH transmissions 204₁ and 204₂, or if the LBT fails for neither of the previous PSFCH transmissions 204₁ and 204₂.

Following a selection of either p₁ₛₜ Or p_{2nd} in accordance with an evaluation of the selection metric, the SL Rx UE performs an LBT procedure based on the determined CAPC (i.e. the selected p₁ₛₜ or p_{2nd}) to seek to transmit the PSFCH transmission 205₁ over PSFCH 2031.

FIG. 12 illustrates a further example of determining CAPC for PSFCH in accordance with the present disclosure.

In this example:
the first candidate CAPC p₁ₛₜ (referred to as the first CAPC) is determined based on the lowest priority of the associated PSSCH A/B 202₁ and 202₂, i.e. p₁ₛₜ=min (p_{A}, p_{B});
the second candidate CAPC p_{2nd} (referred to as the second CAPC) is configured with a CAPC with the lowest possible p value, i.e. p_{2nd}=1; and
the selection metric M1 is applied for CAPC selection.

By default, the first candidate CAPC p₁ₛₜ would be selected for channel access to transmit the PSFCH transmission 205₁ and 205₂ over PSFCH 203₁ at slot #n, i.e. selecting p=p₁ₛₜ. However, in this particular example, since a previous transmission of HARQ feedback 204₁ over PSFCH 2032 for PSCCH/PSSCH A 202₁ was blocked at slot #(n-4) due to LBT failure (wherein such a previous PSFCH transmission 204₁ had been allocated a “primary” PSFCH resource 2061), a secondary PSFCH resource 2062 at slot #n is configured to re-transmit the HARQ feedback 205₁ of PSCCH/PSSCH A 202₁ over PSFCH 203₁. In this scenario, and based on selection metric M1, the SL Rx UE selects the second candidate CAPC for transmitting the PSFCH transmission 205₁ over PSFCH 203₁ at slot #n, i.e. the SL Rx UE selects p=p_{2nd}. Having thereby determined a CAPC for PSFCH (i.e. in this example, p=p_{2nd}), the SL Rx UE performs an LBT procedure based on the determined CAPC to seek to transmit the PSFCH transmission 205₁ over PSFCH 203₁.

Although specific terms are employed herein, they are used in a generic and descriptive sense only and not for purposes of limitation.

Features described in the preceding description may be used in combinations other than the combinations explicitly described.

Although functions have been described with reference to certain features, those functions may be performable by other features whether described or not.

Although features have been described with reference to certain examples, those features may also be present in other examples whether described or not. Accordingly, features described in relation to one example/aspect of the disclosure may include any or all of the features described in relation to another example/aspect of the disclosure, and vice versa, to the extent that they are not mutually inconsistent.

Although various examples of the present disclosure have been described in the preceding paragraphs, it should be appreciated that modifications to the examples given may be made without departing from the scope of the invention as set out in the claims. For example, various of the above examples have been disclosed with reference to the method being performed by an SL-U Rx UE (e.g. a UE configured for SL communication in an unlicensed band acting as a receiver of an SL transmission initiated by an SL-U Tx UE), and wherein the transmission, for which information indicative of a channel access priority is determined, is a PSFCH transmission (such as HARQ feedback) transmitted over PSFCH. However, it is to be appreciated that examples of the present disclosure are not limited to: determining a priority for a PSFCH transmission, the transmission (for which information indicative of a channel access priority is determined) being a PSFCH transmission, nor indeed are examples limited to SL communication and operation in an unlicensed band. In some examples, transmission channel may be a PSSCH or synchronization signal block, SSB.

Various of the above examples have been disclosed with reference to determining first and second candidate CPAC values, and selecting one of the first and second CPAC. However, it is to be appreciated that, in some examples, one or more additional candidate CPAC values may be determined, and one or more of the plurality of candidate CPAC values may be selected.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components may exist (including no intervening components), i.e. so as to provide direct or indirect connection/coupling/communication. Any such intervening components may include hardware and/or software components.

As used herein, the term “determine/determining” (and grammatical variants thereof) may include, not least: calculating, computing, processing, deriving, measuring, investigating, identifying, looking up (for example, looking up in a table, a database or another data structure), ascertaining and the like. Also, “determining” may include receiving (for example, receiving information), accessing (for example, accessing data in a memory), obtaining and the like. Also, “determine/determining” may include resolving, selecting, choosing, establishing, and the like.

References to a parameter (for example: p₁ₛₜ, p_{2nd}, p_{offset}, X, y, and y %) may be replaced by references to “data indicative of”, “data defining” or “data representative of” the relevant parameter if not explicitly stated.

In this description, reference has been made to various examples. The description of features or functions in relation to an example indicates that those features or functions are present in that example. The use of the term ‘example’ or ‘for example’, ‘may’ or ‘may’ in the text denotes, whether explicitly stated or not, that such features or functions are present in at least the described example, whether described as an example or not, and that they may be, but are not necessarily, present in some or all other examples. Thus ‘example’, ‘for example’, ‘may’ or ‘may’ refers to a particular instance in a class of examples. A property of the instance may be a property of only that instance or a property of the class or a property of a sub-class of the class that includes some but not all of the instances in the class.

In this description, references to “a/an/the” [feature, element, component, means . . . ] are used with an inclusive not an exclusive meaning and are to be interpreted as “at least one” [feature, element, component, means . . . ] unless explicitly stated otherwise. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasise an inclusive meaning but the absence of these terms should not be taken to infer any exclusive meaning. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The presence of a feature (or combination of features) in a claim is a reference to that feature (or combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

In the above description, the apparatus described may alternatively or in addition comprise an apparatus which in some other examples comprises a distributed system of apparatus, for example, a client/server apparatus system. In examples where an apparatus provided forms (or a method is implemented as) a distributed system, each apparatus forming a component and/or part of the system provides (or implements) one or more features which collectively implement an example of the present disclosure. In some examples, an apparatus is re-configured by an entity other than its initial manufacturer to implement an example of the present disclosure by being provided with additional software, for example by a user downloading such software, which when executed causes the apparatus to implement an example of the present disclosure (such implementation being either entirely by the apparatus or as part of a system of apparatus as mentioned hereinabove).

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavouring in the foregoing specification to draw attention to those features of examples of the present disclosure believed to be of particular importance it should be understood that the applicant claims protection in respect of any patentable feature or combination of features hereinbefore referred to and/or shown in the drawings whether or not particular emphasis has been placed thereon.

The examples of the present disclosure and the accompanying claims may be suitably combined in any manner apparent to one of ordinary skill in the art. Separate references to an “example”, “in some examples” and/or the like in the description do not necessarily refer to the same example and are also not mutually exclusive unless so stated and/or except as will be readily apparent to those skilled in the art from the description. For instance, a feature, structure, process, block, step, action, or the like described in one example may also be included in other examples, but is not necessarily included.

Each and every claim is incorporated as further disclosure into the specification and the claims are embodiment(s) of the present disclosure. Further, while the claims herein are provided as comprising specific dependencies, it is contemplated that any claims may depend from any other claims and that to the extent that any alternative embodiments may result from combining, integrating, and/or omitting features of the various claims and/or changing dependencies of claims, any such alternative embodiments and their equivalents are also within the scope of the disclosure.

1-23. (canceled)

24. An apparatus comprising:
at least one processor; and
at least one memory storing instructions that, when executed by the at least one processor, cause the apparatus at least to:
determine information indicative of a channel access priority for a physical sidelink feedback channel, PSFCH, transmission based at least in part on:
information indicative of at least one status of a last at least one PSFCH transmission; or
information indicative of a cast type of a sidelink, SL, transmission that is associated with the PSFCH transmission.

25. The apparatus of claim 24, wherein, the PSFCH transmission is in an unlicensed band.

26. The apparatus of claim 24, wherein the information indicative of a channel access priority is indicative of at least one selected from the group of:
a priority class for use in a Listen Before Talk, LBT, procedure;
a priority class for use in an unlicensed band;
a Channel Access Priority Class, CAPC;
a Contention Window, CW; and
a Channel Occupancy Time, COT.

27. The apparatus of claim 24, wherein the information indicative of at least one status of the last at least one PSFCH transmission comprises information indicative of at least one selected from the group of:
a channel access status of the last at least one PSFCH transmission;
whether the last at least one PSFCH transmission failed or was successful;
whether an LBT procedure, for transmitting the last at least one PSFCH transmission, failed or was successful;
an LBT success rate for the last one or more PSFCH transmissions;
a number of LBT successes for the last one or more PSFCH transmissions;
whether the PSFCH transmission comprises a re-transmission of information that failed to be successfully transmitted via the last at least one PSFCH transmission;
allocation of resources for the PSFCH transmission, wherein the resources are allocated for re-transmitting information that failed to be successfully transmitted via the last at least one PSFCH transmission; and
whether the PSFCH transmission is within a channel occupancy time, COT, shared by a UE.

28. The apparatus of claim 24, wherein determining information indicative of the channel access priority for the PSFCH transmission comprises:
determining a first candidate priority class for the PSFCH transmission;
determining a second candidate priority class for the PSFCH transmission; and
selecting at least one of a first candidate priority class and a second candidate priority class.

29. The apparatus of claim 28, wherein at least one selected from the group of:
the first and/or second candidate priority classes are pre-defined;
the first and/or second candidate priority classes are configured to the apparatus;
the first candidate priority class is configured to have a lower channel access priority than the second candidate priority class;
the first candidate priority class is determined based at least in part on a channel access priority of one or more SL transmissions associated with the transmission;
the second candidate priority class is determined based at least in part on a channel access priority of one or more SL transmissions associated with the transmission;
the second candidate priority class is determined based at least in part on the first candidate priority class; and
the second candidate priority class is determined based at least in part on the first candidate priority class and a priority class offset.

30. The apparatus of claim 28, wherein selecting one of the first and second candidate priority classes comprises selecting one of the first and second candidate priority classes in accordance with at least one selection criterion.

31. The apparatus of claim 30, wherein the at least one selection criterion comprises selecting the first candidate priority class by default.

32. The apparatus of claim 30 wherein the at least one selection criterion comprises selecting the second candidate priority class in response to at least one of:
determining whether the PSFCH transmission is a retransmission of at least a part of a previously attempted PSFCH transmission;
determining whether the PSFCH transmission is a re-transmission of feedback previously attempted to be transmitted;
determining whether the PSFCH transmission is a re-transmission of a Hybrid Automatic Repeat Request Acknowledgement, HARQ-ACK, or Negative Acknowledgement, NACK previously attempted to be transmitted;
determining a type of resource for the PSFCH transmission;
determining whether resources allocated for the PSFCH transmission are resources allocated for re-transmitting information that failed to be successfully transmitted via the last at least one PSFCH transmission; and
determining whether at least a HARQ-ACK of a last one or more PSFCH transmissions could not be transmitted via earlier allocated resources due to an LBT failure.

33. The apparatus of claim 30, wherein the at least one selection criterion comprises selecting the second candidate priority class in response to:
determining whether an LBT success rate of a number of previous PSFCH transmissions is less than a threshold value.

34. The apparatus of claim 30, wherein the at least one selection criterion comprises selecting the second candidate priority class in response to:
determining whether a number of LBT successes of a number of the last PSFCH transmissions is less than a threshold value.

35. The apparatus of claim 30, wherein the at least one selection criterion comprises selecting the second candidate priority class in response to:
determining whether the SL transmission is a unicast transmission.

36. The apparatus of claim 30, wherein the instructions, when executed by the at least one processor, further cause the apparatus to perform:
receiving configuration information for enabling the apparatus to determine the at least one selection criterion to apply for selecting one of the first candidate priority class and the second candidate priority class.

37. The apparatus of claim 30, wherein the instructions, when executed by the at least one processor, further cause the apparatus to perform:
determining at least one selection criterion to apply based at least in part on a cast type of the SL transmission that is associated with the PSFCH transmission.

38. The apparatus of claim 24, wherein the instructions, when executed by the at least one processor, further cause the apparatus to perform:
receiving configuration information for enabling the apparatus to determine the information indicative of the channel access priority for the PSFCH transmission.

39. The apparatus of claim 38, wherein the configuration information comprises an indication of at least one selected from the group of:
a first candidate priority class;
a second candidate priority class;
an offset between a first candidate priority class and a second candidate priority class;
a number of the last PSFCH transmissions;
a threshold transmission success rate;
a threshold number of successful transmissions;
the cast type of the SL transmission that is associated with the PSFCH transmission; and
one or more selection criteria the apparatus is to apply.

40. The apparatus of claim 24, wherein the cast type comprises at least one of: a groupcast and a unicast.

41. The apparatus of claim 24, wherein the SL transmission that is associated with the PSFCH transmission comprises a physical sidelink shared channel, PSSCH, transmission.

42. The apparatus of claim 24, wherein the instructions, when executed by the at least one processor, further cause the apparatus to:
cause performance of a channel access procedure for transmitting the transmission based at least in part on the determined information indicative of a channel access priority.

43. A User Equipment, chipset, circuitry or module comprising the apparatus of claim 24.

44-45. (canceled)
